(19) United States
(12) Patent Application Publication
(10) Pub. No.: US 2015/0115705 A1
(43) Pub. Date: Apr. 30, 2015

(54) CIRCUIT ARRANGEMENT AND A METHOD FOR CONTROLLING AN AC DRIVE SYSTEM OF AN ELECTRIC VEHICLE

(71) Applicant: DEBRECENI EGYETEM, Debrecen (HU)

(72) Inventors: János Toth, Debrecen (HU); Attila Vitez, Hajduszoboszlo (HU); Istvan Liker, Devavanya (HU); Geza Husi, Debrecen (HU); Istvan Bartha, Debrecen (HU)

(21) Appl. No.: 14/395,857

(22) PCT Filed: Apr. 19, 2013
(86) PCT No.: PCT/IB2013/053115

§ 371 Date: Oct. 21, 2014

(30) Foreign Application Priority Data
Apr. 21, 2012 (HU) P1200240

(51) Int. Cl. B60L 15/20; B60L 11/18

(52) U.S. Cl. CPC B60L 15/20; B60L 11/1803
USPC 307/9.1

(57) ABSTRACT

Circuit arrangement for controlling an AC drive system of an electric vehicle comprising at least one asynchronous drive motor (1) associated with at least one wheel of the vehicle, at least one frequency converter unit (3) having at least one AC heavy-current input and at least one AC heavy-current output (U/T1, V/T2, W/T3), the at least one AC heavy-current output (U/T1, V/T2, W/T3) is in connection with the at least one asynchronous drive motor (1), a battery unit (7) supplying current consumers of the vehicle, including the at least one frequency converter unit (3), a control unit (19) connected to the at least one frequency converter unit (3), wherein a direct current output of the battery unit (7) is connected through a switching unit (5) to terminals (+,−) for an optional external DC choke of the at least one frequency converter unit (3, 4). A method for controlling an AC drive system of an electric vehicle, comprising the steps of generating alternating current from a direct current supply voltage by a frequency converter unit (3, 4) having at least one DC heavy-current input and at least one DC heavy-current (U/T1, V/T2, W/T3) output, supplying at least one asynchronous drive motor (1) associated with at least one wheel of the vehicle with the generated alternating current, and supplying the frequency converter units (3, 4) with direct current through terminals (+, −) of the frequency converter units (3, 4) serving for connecting a damping DC choke.

The invention relates to a circuit arrangement for controlling an alternating current, AC, drive system of an electric vehicle, said vehicle comprising at least one asynchronous drive motor associated with at least one wheel of the vehicle, at least one frequency converter unit having at least one AC heavy-current input and at least one AC heavy-current output, the at least one AC heavy-current output is in connection with the at least one asynchronous drive motor, a battery unit supplying current consumers of the vehicle, including the at least one frequency converter unit, and a control unit connected to the at least one frequency converter unit.

The invention also relates to a method for controlling an alternating current, AC, drive system of an electric vehicle, comprising the steps of generating alternating current from a direct current supply voltage by a frequency converter unit having at least one DC heavy-current input and at least one DC heavy-current output, and supplying at least one asynchronous drive motor associated with at least one wheel of the vehicle with the generated alternating current.

Electric vehicles generally use direct current, DC, motors, the rotational speed of which, and hence the speed of the vehicle, drops with the decrease of the voltage of the power supply (due to battery run-down). Due to their favourable efficiency rate and simple structure, asynchronous alternating current, AC, motors are extensively used in up-to-date hybrid passenger cars and high-performance electric vehicles. Their drawback is that revolution cannot be regulated by traditional means at all; the increase of the voltage and/or the power causes no speed increase, it only raises the delivered torque.

How to regulate the revolution of the electric motor by efficient means and what is the ratio of the effective range and the mass of the batteries: these are basic issues of the development of electric vehicles.

US 2011/0172859 A1 discloses a pulse width modulation (PWM) frequency adaptation mechanism applicable for the drive system of an electric vehicle, wherein control signals to be used in the converter to influence the converter's output signal are produced by the pulse frequency adaptation mechanism from various vehicle parameters—including the control signals provided by the driver of the vehicle. In this solution, the direct current voltage generated by batteries to supply the vehicle is connected to the input of the converter in the traditional way, and the desired output signal is produced by traditional control of the converter.

U.S. Pat. No. 8,020,651 B2 discloses a hybrid motor vehicle and a method for controlling it, wherein the direct current supply of the electric drive system, i.e. the battery unit, is conducted to the voltage input of a heavy-current electric unit, and its output is connected in the usual way to the drivetrain of the vehicle.

US 2009/0243523 A1 discloses a hybrid vehicle drive system, wherein two asynchronous motors are connected to the wheels of the vehicle by mechanical gears and the motors are in connection with the outputs of a control unit, whereas the input of the control unit is in connection with a battery pack providing for the power supply of the vehicle. The document indicates as technical shortcoming the existence and the uncertain or in some cases faulty operation of this coupling unit, and proposes as its object to eliminate this error and/or any overvoltage that may occur as a result of this error in recharging mode.

Based on the current state of the art, no drive control exists for the AC drive of electric vehicles that could co-operate with the electric and/or electronic control means being manufactured in large series and hence cheaply available to date without requiring their transformation, and/or necessitating operation close to their respective threshold values; hence the development and implementation of the various drives demands significant intellectual and financial inputs.

To our best knowledge this demand has remained unsatisfied to this day; therefore, our object is to create a circuit arrangement and a method suitable for controlling the AC drive of an electric vehicle in a simple and reliable way, at low cost.

An asynchronous AC motor, supported by a frequency converter, has a much more favourable characteristic curve than the DC motors. In practice, this means that, at high starting torque, the torque associated with the characteristic curve modified by the frequency converter is constant up to the rotational speed associated with the breakdown torque, that is, the maximum torque is available also at higher revolutions and speeds, in contrast with the DC engines.

The novelty of our circuit arrangement and method lies in the way we apply a pre-programmed frequency converter that is not used for this purpose, albeit it is well-known in industry. Notably, instead of using the normal AC input of the frequency converter for supplying energy, the direct current voltage is supplied to the so-called intermediate circuitry by generating alternating voltage of a frequency that can be used directly for driving the vehicle from DC on the input side, by a programmable converter.

Based on the recognition outlined above, the task has been solved on the one hand via a circuit arrangement for controlling an alternating current, AC, drive system of an electric vehicle, said vehicle comprising at least one asynchronous drive motor associated with at least one wheel of the vehicle, at least one frequency converter unit having at least one AC heavy-current input and at least one AC heavy-current output, the at least one AC heavy-current output is in connection with the at least one asynchronous drive motor, a battery unit supplying current consumers of the vehicle, including the at least one frequency converter unit, and a control unit connected to the at least one frequency converter unit, wherein a direct current output of the battery unit is connected through a switching unit to terminals for an optional external DC choke of the at least one frequency converter unit.

According to a preferred embodiment of the invention the at least one frequency converter unit comprises a frequency converter of type ATV71HU55M3.

According to a further preferred embodiment of the invention the circuit arrangement comprises a battery charging unit connected to the battery unit.

According to a further preferred embodiment of the invention the battery unit is assembled from two battery packs connected electrically serially.

According to a further preferred embodiment of the invention each battery pack is a battery pack of a nominal voltage of 152 V and a capacity of 45 Ah.

According to a further preferred embodiment of the invention the battery pack is build of lithium-polymer cells.

According to a further preferred embodiment of the invention each battery pack comprises 216 battery cells of a nominal voltage of 4.2 V and a capacity of 7.5 Ah.

According to a further preferred embodiment of the invention shut-down relays are associated with the battery packs, each shut-down relays is connected between one of the electric output terminals of the battery pack and the terminal of a battery cell included therein.

According to a further preferred embodiment of the invention the actuating coil of the relay is powered by an auxiliary battery through an emergency switch.

According to a further preferred embodiment of the invention the emergency switch is a manually operated switch.

According to a further preferred embodiment of the invention the emergency switch is an impact-sensitive switch.

According to a further preferred embodiment of the invention the battery charging unit is provided with a standardised input connector.

According to a further preferred embodiment of the invention the asynchronous drive motor is directly associated with a vehicle wheel.

According to a further preferred embodiment of the invention the asynchronous drive motor is associated with one vehicle wheel through a mechanical gear.

According to a further preferred embodiment of the invention the circuit arrangement comprises two frequency converter units associated directly with drive motors connected to one vehicle wheel each, and the two frequency converter units are interconnected in master-slave mode.

According to a further preferred embodiment of the invention the control unit electrically connected to the frequency converter units comprises a potentiometer for controlling the acceleration and deceleration of the vehicle.

According to a further preferred embodiment of the invention the control unit electrically connected to the frequency converter units comprises a switch causing the vehicle to decelerate.

According to a further preferred embodiment of the invention the circuit arrangement comprises a cooling fan associated with the drive motor.

According to a further preferred embodiment of the invention the cooling fan is connected via a thermoswitch to the auxiliary battery.

Based on the recognition outlined above, the task has been solved on the other hand via a method for controlling an alternating current, AC, drive system of an electric vehicle, comprising the steps of generating alternating current from a direct current supply voltage by a frequency converter unit having at least one DC heavy-current input and at least one DC heavy-current output, and supplying at least one asynchronous drive motor associated with at least one wheel of the vehicle with the generated alternating current, further comprising the step of supplying the frequency converter units with direct current through terminals of the frequency converter units serving for connecting a damping DC choke.

A further preferred embodiment of the invention comprises the step of using a frequency converter of type ATV71HU55M3 as the frequency converter unit.

A further preferred embodiment of the invention comprises the step of setting the magnitude of the alternating current being generated via the exciting frequency of the frequency converter units.

A further preferred embodiment of the invention comprises the step of setting the exciting frequency of the frequency converter units via a potentiometer of a control unit for controlling the acceleration and deceleration of the vehicle that is in electrical connection with the frequency converter unit.

A further preferred embodiment of the invention comprises the step of continuously measuring the rotational speed of the drive motor, and in addition applying torque limitation based on the rotational speed and potentiometer position readings ever by setting the exciting frequency of the frequency converter unit.

A further preferred embodiment of the invention comprises the step of continuously changing torque limiting based on the rotational speed and potentiometer position readings ever.

A further preferred embodiment of the invention comprises the step of determining the difference between the revolutions of the right-hand and left-hand steered wheels and adjusting the rotational speed of the drive motors assigned to the respective wheels according to the determined difference.

A further preferred embodiment of the invention comprises the step of measuring the revolutions of the respective wheels by inductive angular position signal transmitters.

A further preferred embodiment of the invention comprises the step of setting the output signal of the angular position signal transmitters to default position when the steering wheel of the vehicle is in neutral mid-gear position.

A further preferred embodiment of the invention comprises the step of the drive motor is cooled in function of its temperature by a fan supplied by a supply unit that is independent of the direct current power supply unit supplying the drive motor.

A further preferred embodiment of the invention comprises the step of connecting the direct current power supply to the terminals of the frequency converter unit via an impact-sensitive switch assigned to the vehicle.

A further preferred embodiment of the invention comprises the step of connecting the direct current power supply to the terminals of the frequency converter unit via a thermoswitch applied as switching unit.

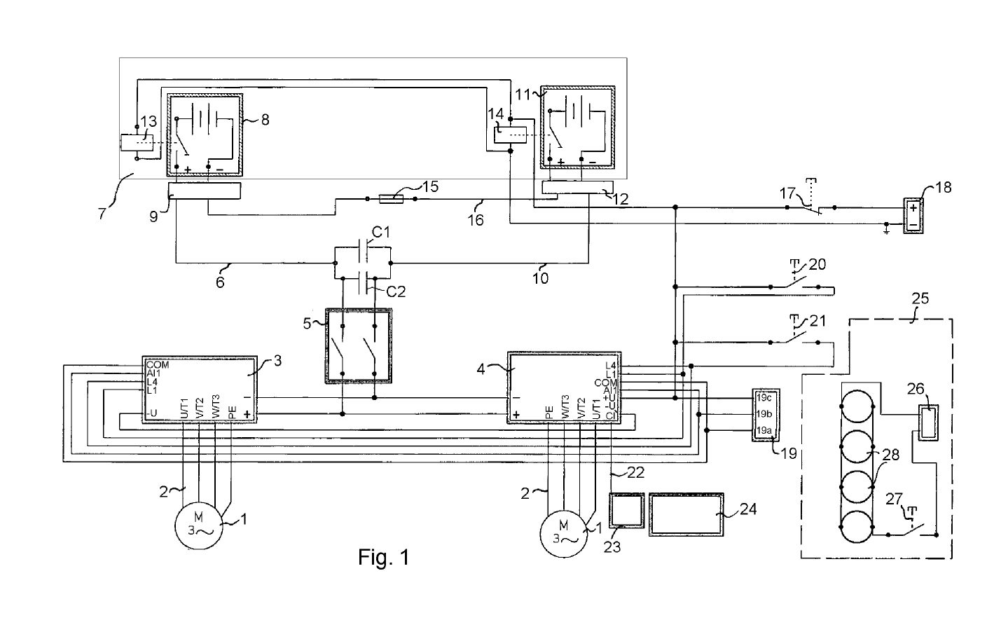

The invention will be described in more detail with reference to the attached drawing showing an exemplary implementation of the proposed method and the proposed circuit arrangement. In the drawing, FIG. 1 shows the block diagram of a preferred embodiment of the proposed circuit arrangement.

The block diagram shown in the drawing exemplifies but one possible and preferred embodiment of the circuit arrangement according to the invention, but as will be obvious to persons skilled in the art that its individual components, functional units and blocks can also be replaced by components and blocks suitable for solving the task, available commercially and/or being well-known.

The electric drive system according to the invention concerns a DC drive regulated by a heavy-current microcomputer-based frequency converter, more precisely a power electronic circuit arrangement that regulates the forced frequency of the AC drive motor.

The FIGURE shows exclusively the electrical circuit diagram; to facilitate understanding, the vehicle and the affected vehicle parts are omitted from the FIGURE partly because they are well-known and partly for the sake of simplicity. As recently is frequent with the electric drives related to vehicles, the vehicle is driven in the present case, too, by drive motors 1 directly connected on an appropriate bogie or running gear to a wheel of a vehicle. In the case shown here, two drive motors 1 are used which are meant to drive the rear wheels of a vehicle. A person skilled in the art will be able to FIGURE out and understand that drive motors 1 can be designed not as separate and self-standing motors, but they can be designed also in other known ways, e.g. realised as wheel hub motors, provided that the drive motors 1 can be designed in a way considering also the related, decisively mechanical and thermal criteria. According to a further option, it is possible to use only one single drive motor 1, also associated in the known way to some mechanical gear with at least one wheel of the vehicle. In line with the old traditional drives, drive motor 1 may also drive a cardan shaft, and the cardan shaft may provide for the drive of the rear wheels of the vehicle through a compensating gear.

The power of the six-pole asynchronous drive motors 1 used in the example shown here is: 2*4 kW.

The drive motor 1 is connected through lines 2 that are of appropriate cross-section, a cross-section of at least 2.5 mm², to outputs U/T1, V/T2, W/T3 of a frequency converter unit 3. Since in the example shown here the two rear wheels of the vehicle are driven separately, two drive motors 1 are used, and hence drive motors 1 are connected to the appropriate U/T1, V/T2, W/T3 outputs of the two frequency converter units 3, 4. The +, − terminals of the frequency converter units 3, 4 are connected to each other and they are conducted to corresponding terminals of a bipolar thermal circuit breaker applied as switching unit 5. Filter capacitors C1, C2 are connected in between the other poles of the bipolar circuit breaker, and one pole of the circuit breaker is connected via line 6 to the positive terminal of one battery pack 8 of the battery unit 7 marked with thin line through a connector 9, whereas the other pole of the circuit breaker is connected via line 10 to the negative terminal of the other battery pack 11 of the battery unit 7 through a connector 12. Battery packs 8, 11 comprise battery cells indicated in the FIGURE symbolically only for the sake of simplicity. In each of the battery packs 8, 11 the battery cells are connected to the respective other terminals of the battery packs 8, 11 through the contacts of the relays 13, 14 that are open in default setting, and the positive terminal of the battery pack 11 is conducted to the negative terminal of the battery pack 8 through the connector 12 and in the present example also through a 40 A fuse 15 via line 16 through the connector 9, that is, the battery unit 7 comprises two serially connected battery packs 8, 11. Relays 13, 14 may be placed within the battery packs 8, 11, but may be placed also externally.

In the present case, each of the battery packs 8, 11 comprises 216 battery cells, each of a nominal voltage of 4.2 V and a capacity of 7.5 Ah, arranged in serial/parallel connection in a way that is understandable and known to a person skilled in the art and that produces a nominal voltage of 152 V measurable at the terminals of each of the battery packs 8, 11, so that each of the battery packs 8, 11 has a capacity of 45 Ah. Since the battery packs 8, 11 are connected serially, all in all a battery unit 7 of nominal voltage of 304 V and of nominal capacity of 54 Ah will be available for driving the vehicle.

The relays 13, 14 assigned to the respective battery packs 8, 11 are parallel connected with one another, and are connected directly to the auxiliary battery 18 through an emergency shut-down switch 17 that is closed in default position. The emergency shut-down switch 17 may be an usual mechanical switch 17, preferably arranged within easy reach of the driver of the vehicle, but additionally or alternatively the switch 17 may also be an impact-sensitive switch to be released and hence open the circuit of the relays 13, 14 under the effect of the vehicle being hit.

Terminals +U, −U, COM, AI1 of the frequency converter unit 3 are connected to the terminals +U, −U, COM, AI1 of the frequency converter unit 4. The terminals COM and AI1 of the frequency converter unit 3 are also connected to the terminals 19a, 19b of a control unit 19, and a further terminal 19c of the control unit 19 is connected to the positive terminal of the auxiliary battery 18, together with the terminal +U of the frequency converter unit 4. As will be understood by a person skilled in the art, the negative pole of the auxiliary battery 18 used in this embodiment is connected to the metallic body of the vehicle, that is, it can be regarded as body potential, and it is the positive terminal of the auxiliary battery 18 that represents the supply voltage for the various units connected to it. In the example shown here, the auxiliary battery 18 is a sealed gel battery of a nominal voltage of 24 V and a capacity of 7 Ah, arranged in the vehicle that is not shown in the drawing in a fixed, but easily accessible and replaceable manner, similarly to the battery packs 8, 11 of the battery unit 7.

In the example shown here, the control unit 19 is essentially a potentiometer, in regard of which the decisive requirements set in this embodiment are also that it should provide for the presence of the control signal necessary for the frequency converter unit 4 in a reliable way, without interruption and for a long time. This can be solved in the way known in the field e.g. through the mechanical and electrical interconnection of even several potentiometers.

If that potentiometer was to regulate the frequency alone, the resulting vehicle would be difficult to drive as the drive motors 1 would then try to attain the rotational speed determined by the frequency, at the highest power consumption. This is unfavourable, because then the vehicle driver could exert no influence on the torque and hence on acceleration, that is, the vehicle would try to attain the speed determined by the driver at the highest possible acceleration rate. Therefore, the frequency converter units 3, 4 include also real-time torque limiting function based on the rotational speed and the position of the potentiometer. At full throttle, at higher rotational speed, this no longer limits the delivered power, so it is possible to attain the desired running dynamic properties.

According to a further preferred embodiment, the radius of the curve followed by the wheels of the vehicle can be calculated with the help of an angular position signal transmitter associated with the steering wheel of the vehicle, and that is how the revolution difference of the wheels is given. It is possible to create that way what is essentially an electronically-controlled compensation gear. An inductive signal transmitter is applied to set the incremental angular position signal transmitter being used to a value of zero, and the signal transmitter is set to a value of zero continuously whenever the steering wheel is in its neutral mid-gear position.

One terminal of each of two further switches 20, 21, open in default case, is connected to the positive terminal of the auxiliary battery 18. In the example being shown here, the switch 20 is a key main switch, the other terminal of which is led to control inputs L1 of the frequency converter units 3 and 4, whereas the switch 21 is a switch 21 operated and applied as an electric brake, the other terminal of which is connected to control inputs L4 of the frequency converter units 3 and 4.

The display 24, in the present case a touchscreen display 24, through which the parameters of the frequency converter units 3, 4 can be set and/or programmed, is connected to the AO1 and COM connectors of the frequency converter unit 4 by a communication cable 22 commonly used in this art, through an encoder 23.

In the example shown here, the frequency converter units 3, 4 operate in master-slave mode, with the frequency converter unit 3 operating in master and the frequency converter unit 4 in slave mode; the modes concerned are well-known in this field of expertise and they are easy to be set in the manner that can be understood from the data sheets of the frequency converter units 3, 4.

In the embodiments shown here, the frequency converter units 3, 4 are frequency converters of type Altivar ATV71HU55M3 of Schneider Electric, expanded by an encoder and a control inside card, and their structure, operation, programming, threshold values etc. can be understood in detail by persons skilled in the art from the manufacturer's data sheet.

The FIGURE indicates symbolically, in dashed line, also a cooling unit 25 designed to cool the drive motors 1 used to drive the vehicle or, as the case may be, the battery unit 7 and the frequency converter units 3, 4. The cooling unit 25 is to function while the vehicle is in operation, in movement, but also after it is stopped, in order to prevent the detrimental overheating of certain parts/units. Therefore, the cooling unit 25 has its own auxiliary battery 26, independent of the other power supply units, connected through the thermoswitch 27, which is open in default case, to DC fans 28. According to our calculations and experiments, the auxiliary battery 26 may be a battery with a nominal voltage of 16 V and a capacity of 7 Ah, and even commercially available DC brushless fans may be used as fan 28.

One of the major advantages of the circuit arrangement and method according to the invention, most important from the point of view of the running dynamics of the vehicle is that the torque of the motor is the maximum exactly in the higher rotational speed range, in contrast with the DC motors, and the revolution of the drive (the speed of the vehicle) will not decrease until the voltage of the battery unit 7 drops below a certain pre-set level. In that case, by a software-based adjusting of the frequency converter unit(s), the vehicle can move on to the place where it is recharged. The size of this safety energy reserve depends on the parameter of the battery unit and can also be set from the software.

According to our experiments conducted under normal road traffic conditions, the effective range of the vehicle supplemented with the circuit arrangement according to the invention exceeds 110 km, and its ultimate speed is 80-100 km/h depending on the settings. It is typical of its acceleration that it can increase its speed by 1 km/h per meter up to almost its ultimate speed.

### LIST OF REFERENCE SIGNS

1 drive motor
2 line
3, 4 frequency converter
+, − terminal
U/T1, V/T2, W/T3 output
+U, −U, COM, AI1 terminal
L1 control input
L4 control input
5 switching unit
C1, C2 filter capacitor
6 line
7 battery unit
8 battery pack
9 connector
10 line
11 battery pack
12 connector
13, 14 relay
15 fuse
16 line
17 switch
18 auxiliary battery
19 control unit
19a, 19b, 19c terminal
20, 21 switch
22 cable
23 encoder
24 display
25 cooling unit
26 auxiliary battery
27 thermoswitch
28 fan

1. Circuit arrangement for controlling an alternating current, AC, drive system of an electric vehicle,
said vehicle comprising
at least one asynchronous drive motor (1) associated with at least one wheel of the vehicle,
at least one frequency converter unit (3) having at least one AC heavy-current input and at least one AC heavy-current output (U/T1, V/T2, W/T3), the at least one AC heavy-current output (U/T1, V/T2, W/T3) is in connection with the at least one asynchronous drive motor (1),
a battery unit (7) supplying current consumers of the vehicle, including the at least one frequency converter unit (3),
a control unit (19) connected to the at least one frequency converter unit (3),
characterised in that
a direct current output of the battery unit (7) is connected through a switching unit (5) to terminals (+, −) dedicated for an external DC choke of the at least one frequency converter unit (3, 4).

2. The circuit arrangement according to claim 1, characterised in that the at least one frequency converter unit (3, 4) comprises a frequency converter of type ATV71HU55M3.

3. The circuit arrangement according to claim 1, characterised in that it comprises a battery charging unit connected to the battery unit (7).

4. The circuit arrangement according to claim 1, characterised in that the battery unit (7) is assembled from two battery packs (8, 11) connected electrically serially.

5. The circuit arrangement according to claim 4, characterised in that each battery pack (8, 11) is a battery pack of a nominal voltage of 152 V and a capacity of 45 Ah.

6. The circuit arrangement according to claim 5, characterised in that the battery pack (8, 11) is built of lithium-polymer cells.

7. The circuit arrangement according to claim 6, characterised in that each battery pack (8, 11) comprises 216 battery cells of a nominal voltage of 4.2 V and a capacity of 7.5 Ah.

8. The circuit arrangement according to claim 6, characterised in that shut-down relays (13, 14) are associated with the battery packs (8, 11), each shut-down relay (13, 14) is connected between one of the electric output terminals of the battery pack (8, 11) and the terminal of a battery cell included therein.

9. The circuit arrangement according to claim 8, characterised in that the actuating coil of the relay (13, 14) is connected to an auxiliary battery (18) through an emergency switch (17).

10. The circuit arrangement according to claim 9, characterised in that the emergency switch (17) is a manually operated switch.

11. The circuit arrangement according to claim 9, characterised in that the emergency switch (17) is an impact-sensitive switch.

12. The circuit arrangement according to claim 3, characterised in that the battery charging unit is provided with a standardised input connector.

13. The circuit arrangement according to claim 1, characterised in that the asynchronous drive motor (1) is directly associated with a vehicle wheel.

14. The circuit arrangement according to claim 1, characterised in that the asynchronous drive motor (1) is associated with one vehicle wheel through a mechanical gear.

15. The circuit arrangement according to claim 1, characterised in that it comprises two frequency converter units (3, 4) associated directly with drive motors (1) connected to one vehicle wheel each, and the two frequency converter units (3, 4) are interconnected in master-slave mode.

16. The circuit arrangement according to claim 1, characterised in that the control unit (19) electrically connected to the frequency converter units (3, 4) comprises a potentiometer for controlling the acceleration and deceleration of the vehicle.

17. The circuit arrangement according to claim 1, characterised in that the control unit (19) electrically connected to the frequency converter units (3, 4) comprises a switch causing the vehicle to decelerate.

18. The circuit arrangement according to claim 1, characterised in that it comprises a cooling fan (28) associated with the drive motor (1).

19. The circuit arrangement according to claim 18, characterised in that the cooling fan (28) is connected via a thermoswitch (27) to the auxiliary battery (26).

20. A method for controlling an alternating current, AC, drive system of an electric vehicle, comprising the steps of
generating alternating current from a direct current supply voltage by a frequency converter unit (3, 4) having at least one DC heavy-current input and at least one DC heavy-current (U/T1, V/T2, W/T3) output, and
supplying at least one asynchronous drive motor (1) associated with at least one wheel of the vehicle with the generated alternating current,
characterised in further comprising the step of
supplying the frequency converter units (3, 4) with direct current through terminals (+, −) of the frequency converter units (3, 4) serving for connecting a damping DC choke.

21. The method according to claim 20, characterised by using a frequency converter of type ATV71HU55M3 as the frequency converter unit (3, 4).

22. The method according to claim 20, characterised by setting the magnitude of the alternating current being generated via the exciting frequency of the frequency converter units (3, 4).

23. The method according to claim 22, characterised by setting the exciting frequency of the frequency converter units (3, 4) via a potentiometer of a control unit (19) for controlling the acceleration and deceleration of the vehicle that is in electrical connection with the frequency converter unit (3, 4).

24. The method according to claim 23, characterised by continuously measuring the rotational speed of the drive motor (1), and in addition applying torque limitation based on the rotational speed and potentiometer position readings ever by setting the exciting frequency of the frequency converter unit (3, 4).

25. The method according to claim 24, characterised by continuously changing torque limiting based on the rotational speed and potentiometer position readings ever.

26. The method according to claim 20, characterised by determining the difference between the revolutions of the right-hand and left-hand steered wheels and adjusting the rotational speed of the drive motors (1) assigned to the respective wheels according to the determined difference.

27. The method according to claim 26, characterised by measuring the revolutions of the respective wheels by inductive angular position signal transmitters.

28. The method according to claim 27, characterised by setting the output signal of the angular position signal transmitters to default position when the steering wheel of the vehicle is in neutral mid-gear position.

29. The method according to claim 20, characterised by the drive motor (1) is cooled in function of its temperature by a cooling fan (29) supplied by a supply unit that is independent of the direct current power supply unit supplying the drive motor (1).

30. The method according to claim 20, characterised by connecting the direct current power supply to the terminals of the frequency converter unit (3, 4) via an impact-sensitive switch assigned to the vehicle.

31. The method according to claim 20, characterised by connecting the direct current power supply to the terminals of the frequency converter unit (3, 4) via a thermoswitch applied as switching unit (5).
